(19) United States
(12) Patent Application Publication
(10) Pub. No.: US 2009/0166553 A1
(43) Pub. Date: Jul. 2, 2009

(54) ELECTRON BEAM DRAWING METHOD

(75) Inventor: Takeshi Okino, Yokohama-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/400,254

(22) Filed: Mar. 9, 2009

Related U.S. Application Data
(63) Continuation of application No. PCT/JP2008/061807, filed on Jun. 24, 2008.

(30) Foreign Application Priority Data
Jun. 29, 2007 (JP) 2007-173475

(51) Int. Cl. H01J 3/14

(52) U.S. Cl. 250/396 R

(57) ABSTRACT

According to one embodiment, an electron beam drawing method includes placing a substrate, on which a photosensitive resin film is coated, on a stage, applying an electron beam to the photosensitive resin film while the substrate on the stage is rotated and moved to the horizontal direction, and drawing a pattern extending to a radial direction, in which the electron beam is deflected to a direction parallel with a rotational direction of the substrate such that a relative movement speed of an electron-beam applied position on the substrate in the direction parallel with the rotational direction of the substrate becomes slower than a linear velocity of the substrate, viewed from a drawing start position in a circulation for drawing the pattern.

### CROSS REFERENCE TO RELATED APPLICATIONS

This is a Continuation Application of PCT Application No. PCT/JP2008/061807, filed Jun. 24, 2008, which was published under PCT Article 21(2) in English.

This application is based upon and claims the benefit of priority from Japanese Patent Application No. 2007-173475, filed Jun. 29, 2007, the entire contents of which are incorporated herein by reference.

### BACKGROUND

1. Field

One embodiment of the present invention relates to an electron beam drawing method for drawing patterns in a discrete track recording-type magnetic disk medium.

2. Description of the Related Art

In technical trends of high-density magnetic disks (hereinafter, also referred to as hard disks), so-called discrete track recording-type magnetic disks, in which magnetic patterns generating magnetic signals are separated by a nonmagnetic material, are proposed. The discrete-type magnetic disks have specific magnetic patterns in data zones on which user data are recorded and servo zones. In order to manufacture the discrete-type magnetic disks, it is advantageous that a stamper master having desired patterns is manufactured by lithography, and imprinting is carried out by using the stamper master.

Jpn. Pat. Appln. KOKAI Publication No. 2005-275186 discloses a method for drawing exposure patterns including track patterns of an information recording medium. In the drawing of circular patterns using a drawing apparatus having an X-Y movement mechanism, movement control of a stage is difficult, and an operation for controlling the drawing according to geometric patterns becomes complicated.

Jpn. Pat. Appln. KOKAI Publication No. 2002-288890 describes a beam irradiation method for irradiating an irradiation object with a beam while the beam is shifted to a movement direction of the object. This method, however, cannot cope with media such as discrete-type magnetic disks which have patterns not only in a circumferential direction but also in a radial direction and media which have patterns with a length of more than a possible deflection amount. When patterns in a form of bi-phase codes (also referred to as Manchester codes) which are used for address marks of a hard disk are drawn, a beam irradiation method for deflecting the beam not only to the movement direction of the object but also to the opposite direction depending on patterns is more preferable than the beam irradiation method for deflecting the beam simply to the movement direction of the object described in Jpn. Pat. Appln. KOKAI Publication No. 2002-288890. This is because, in this method, the deflection amount can be made to be a constant amount or less, namely, one-bit length or less through drawing.

In general, the magnetic disk drives have a donut-shaped magnetic disk, a head slider including a magnetic head, a head suspension assembly which supports the head slider, a voice coil motor (VCM) and a circuit board in a chassis.

The surface of the magnetic disk is defined by concentric tracks, and each track is divided into sectors every constant angle. The magnetic disk is mounted to a spindle motor to be rotated, and various digital data are written to and read out of the magnetic disk with a magnetic head. For this reason, the tracks are arranged in the circumferential direction, while servo marks for position control are arranged in the direction crossing the tracks. A servo zone includes sections such as a preamble section, an address section and a burst section. The servo zone may include a gap in addition to these sections.

In a stamper master used for manufacturing a discrete-type magnetic disk by imprinting, it is desired that both data zone and servo zone can be formed at the same time. This is because, when these zones are formed individually, alignment of these zones becomes difficult and complicated processes are required.

In order to manufacture the master, a photosensitive resin is exposed and developed by lithography so that patterns are formed. Since concentric circles should be drawn, drawing using an electron beam which can be deflected is preferable. Fine patterns like hard disk patterns whose track pith is of sub-micron should be connected accurately. For this reason, a system in which the stage continuously moves is more desirable than a so-called step-and-repeat system because the position control can be made stably.

FIG. 1 schematically illustrates a stage of an r-θ-system electron beam drawing apparatus. The electron beam drawing apparatus has a stage 50 on which a substrate 1 is placed, a rotation mechanism which rotates the stage 50, and a movement mechanism which moves the stage 50 to a horizontal direction. The r-θ-system electron beam drawing apparatus is more preferable for drawing concentric patterns than the X-Y-system electron beam drawing apparatus because it enables simple control. In the r-θ-system electron beam drawing apparatus, a spot beam is applied from one point on a movement axis to a photosensitive resin on the substrate 1 placed on the stage 50, thereby performing electron-beam exposure. In this case, if the electron beam is not deflected, a distance between the rotation center of the substrate and an electron beam applied position becomes longer with time, so that a spiral is drawn as shown in FIG. 2. On the other hand, when the electron-beam is deflected for exposure while deflection strength (deflection amount) is gradually changed per rotation by a deflecting system of the electron beam drawing apparatus, concentric circles can be drawn as shown in FIG. 3.

When an electron beam is not deflected or is deflected slightly in order to draw a concentric circuit in the electron beam drawing apparatus, the electron beam is applied to a photosensitive resin film on the substrate through an aperture. On the other hand, when an electron beam is deflected strongly and is blanked so as to deviate from the aperture, non-exposed portions can be obtained. As a result, the exposed portion and the non-exposed portion are switched at a high speed, and thus patterns with clear edges can be formed.

As a way of stage rotation, CLV (constant linear velocity) or CAV (constant angle velocity) is generally used. CLV is desirable in that an exposure amount of an electron beam per unit area (or unit length) can be constant. In CLV, control is made so that an irradiation radius position r and a rotation number X of the stage per unit time establish an inversely proportional relationship, and a linear velocity Lv is kept constant.

On the other hand, high density is obviously required in discrete-type magnetic disks, and fine patterns are required to be drawn by electron-beam exposure in manufacturing a master. From view points of mass productivity and cost reduction, the electron-beam exposure in manufacturing the master is required to be carried out in as a short time as possible.

In the electron beam drawing, it becomes a problem that resolution is limited by space-charge effect of electron beam, in other words, that electrons traveling an optical path cause Coulomb interaction (space-charge interaction) through Coulomb reactive force exerting between them which in turn cause beam focusing blur, also referred to as Coulomb blur. It is known that the Coulomb blur a is proportional to a beam current I and an optical path length L and is inversely proportional to the three-halves power of an acceleration voltage V, as represented by the following formula (1).

σ∝IL/V^{3/2} (1)

According to the formula (1), decrease in the beam current I is effective for the drawing of fine patterns. In general, the optical path length L and the acceleration voltage V are often set to fixed values in the drawing apparatus. When the beam current I is low, however, the linear velocity is made to be slow so that a predetermined exposure amount should be obtained as long as sensitivity of a photosensitive resin is constant. For this reason, the drawing time becomes long, and thus the mass productivity is lowered.

In the discrete-type magnetic disk, patterns of a preamble section, address section and burst section formed in servo zones are defined by presence and absence of a magnetic material so as to constitute bi-phase codes (also referred to as Manchester codes) or the like. Thus, in general, when servo marks are formed by means of an r-θ type electron drawing apparatus, it is not necessary that portions to be exposed on a positive photosensitive resin film are continued by three bits or more, and also it is not necessary that an electron beam is applied to the photosensitive resin film on the substrate for duration of 50% or more.

As to the tracks arranged in the circumferential direction, it is sufficient only if a magnetic noise from an adjacent track is prevented, and thus a groove width between the tracks may be a half or less and more preferably ⅓ or less of the track pitch or less. When the track pattern is formed, therefore, it is not necessary that an electron beam is applied to the photosensitive resin film on the substrate for duration of 50% or more. Conventionally, when the patterns of the discrete-type magnetic disk are formed on the positive photosensitive resin film using the r-θ electron beam drawing apparatus, the time for which an electron beam is not applied to the photosensitive resin film by exerting blanking is a half or more of the entire drawing time, which leads to low productivity.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a perspective view schematically illustrating a stage of an r-θ electron beam drawing apparatus;

FIG. 2 is a diagram illustrating an exposure example when an electron beam is not deflected;

FIG. 3 is a diagram illustrating an exposure example when an electron beam is deflected so that concentric circles are drawn;

FIG. 4 is a diagram illustrating an example of a drawing method according to the present invention in which one pattern portion is viewed;

FIG. 5 is a diagram illustrating another example of the drawing method according to the present invention in which one pattern portion is viewed;

FIGS. 6A and 6B are diagrams illustrating an example of a desired pattern and an example of a conventional drawing method;

FIGS. 7A and 7B are diagrams illustrating concept of the drawing in a radial direction and an example of the drawing method according to the present invention;

FIGS. 8A and 8B are diagrams illustrating concept of the drawing in a circumferential direction and an example of the drawing method according to the present invention;

FIGS. 9A to 9F are cross-sectional views illustrating a method of manufacturing a stamper according to one embodiment of the present invention;

FIGS. 10A to 10F are cross-sectional views illustrating a method of manufacturing a discrete track recording medium according to one embodiment of the present invention; and

FIGS. 11A to 11D are cross-sectional views illustrating a method of manufacturing a discrete track medium according to another embodiment of the present invention.

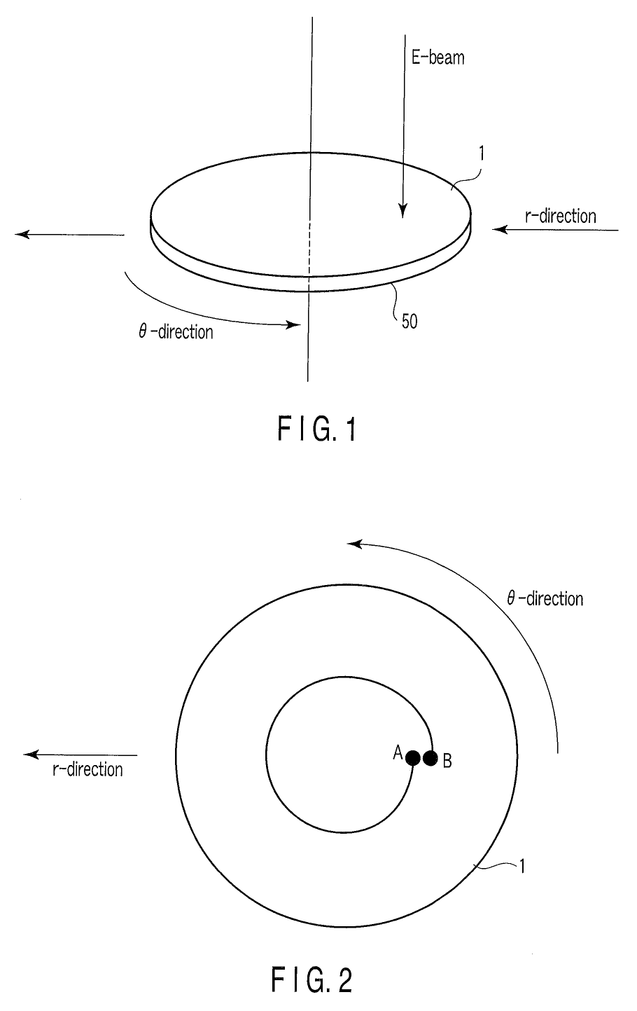

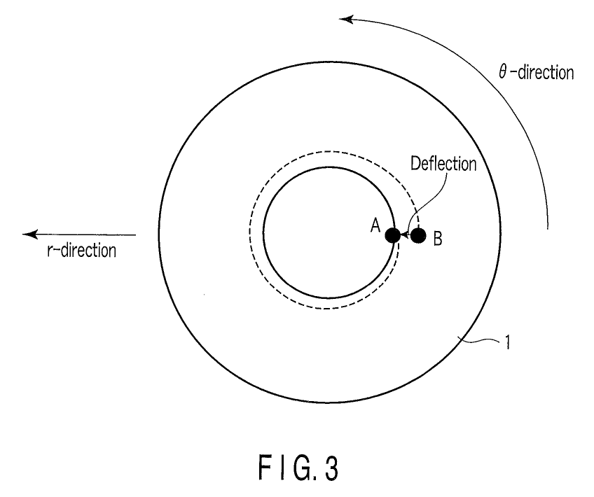

### DETAILED DESCRIPTION

Various embodiments according to the invention will be described hereinafter with reference to the accompanying drawings. In general, according to one embodiment of the invention, there is provided an electron beam drawing method comprising: providing an electron beam drawing apparatus having a stage on which a substrate is placed, a movement mechanism which moves the stage to a horizontal direction and a rotation mechanism which rotates the stage; and placing the substrate, on which a photosensitive resin film is coated, on the stage, applying an electron beam to the photosensitive resin film while the substrate on the stage is rotated and moved to the horizontal direction, and drawing a pattern extending to a radial direction, characterized in that the electron beam is deflected to a direction parallel with a rotational direction of the substrate such that a relative movement speed of an electron-beam applied position on the substrate in the direction parallel with the rotational direction of the substrate becomes slower than a linear velocity of the substrate, viewed from a drawing start position in a circulation for drawing the pattern.

In the present invention, an electron beam may be deflected to a direction parallel with a rotational direction of a substrate and to a radial direction. In this case, a deflection amount in the radial direction is a pitch in the radial direction per rotation or less, and more preferably a half of the pitch or less. As a result, a pattern in the radial direction can be drawn smoothly.

Exposure with an electron beam may be started from an inner peripheral side or an outer peripheral side, or some divided zones may be exposed. In order to obtain an OFF state during the exposure of a portion corresponding to a bit pattern, a deflection signal may be given so that an electron beam is blanked in an electron beam drawing apparatus.

In the present invention, when assuming that a movement speed of the electron beam is V and a linear velocity of the substrate is L, an electron beam may be deflected so that the following relationship is satisfied: L/2≦V<L, and the electron beam applied position on the substrate moves to the same direction as the rotational direction of the substrate. An embodiment which satisfies such a relationship can be effectively used for a pattern which extends to the radial direction using description as bi-phase codes (also called as Manchester codes), in which the codes are arranged in a circumferential direction, or a pattern which extends to the radial direction and whose duty is 50% or less.

In the present invention, the electron beam is deflected to an opposite direction to the rotational direction of the substrate within a range which is twice or less of a bit length on a radial position where the bit is present at the time when that bit is started to be drawn. This embodiment can cope with a case where two bit portions to be exposed continue.

In the present invention, photosensitive resin may be positive resist or negative resist, and further chemically-amplified resist including a material which generates acid due to exposure (hereinafter, referred to as an acid-generating agent) or non-chemically-amplified resist. With the positive photosensitive resin, the areas to be exposed can be smaller than the negative photosensitive resin, and thus it is preferable in view of sensitivity and resolution. In particular, the non-chemically-amplified positive resist is preferably used because it has satisfactory sensitivity to an electron beam and is stable, and has satisfactory resolution. Materials mainly containing PMMA (polymethylmethacrylate) and novolac resin can also be used. Dry etching resistance is not particularly limited.

In the present invention, in drawing a pattern extending to a circumferential direction, an electron beam may be deflected to the radial direction in a circulation on a vicinity of the pattern, so that the pattern may be multiply exposed. According to this embodiment, also as to the pattern which extends to the circumferential direction, the drawing time can be shortened, and thus this embodiment is effective particularly for forming grooves between discrete tracks.

Examples of patterns to be formed by the method of the present invention include patterns of a discrete-type magnetic disk including a preamble pattern and a discrete track pattern.

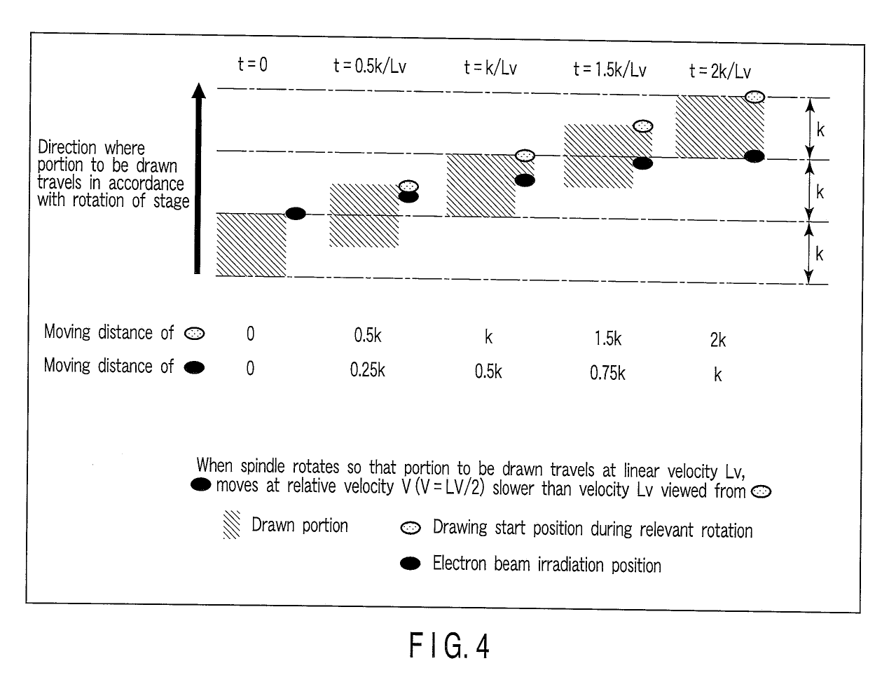

An electron beam drawing method according to the embodiment of the present invention is described with reference to FIGS. 4, 5, 6A, 6B, 7A, 7B 8A and 8B.

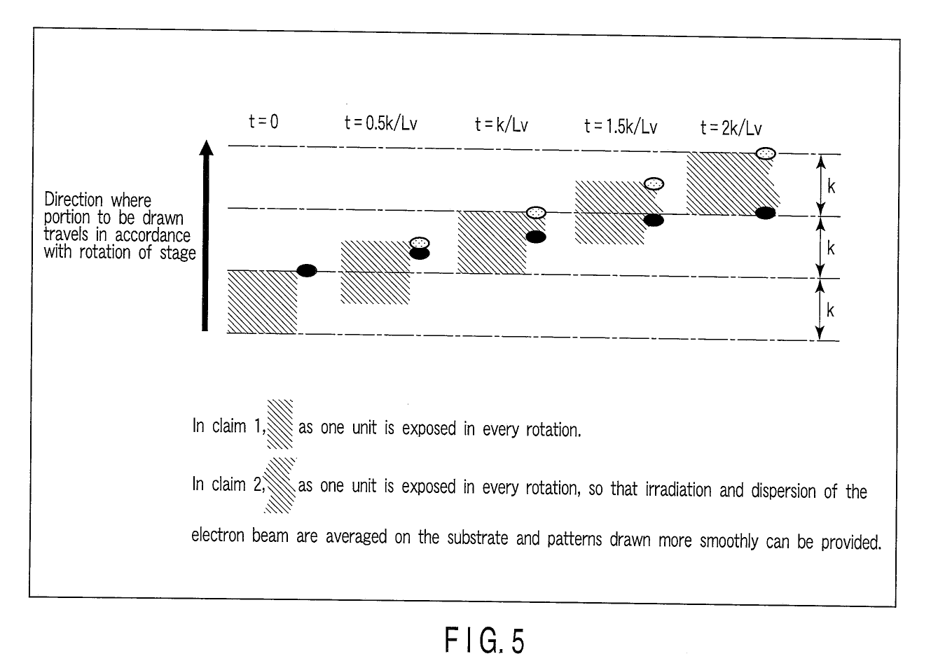

FIGS. 4 and 5 illustrate examples of the drawing method of the present invention in which one pattern portion to be drawn is viewed. The drawing start position is moved by the rotation of the stage at a certain linear velocity Lv and simultaneously the electron beam irradiation position is moved as shown in the drawings. As a result, a distance k can be drawn for time t=2k/Lv. If an electron beam is not deflected unlike the present invention, the drawing of the distance k is finished for the time k/Lv, and necessary exposure time, namely, necessary exposure amount cannot be obtained. FIG. 5 illustrates the example in the case where an electron beam is deflected also to the radial direction in addition to the case of FIG. 4. Also in this case, the same effect can be obtained as to the exposure amount, and the irradiation and scattering of an electron beam are easily uniformed on the substrate, so that a smooth drawn pattern can be obtained.

The drawing method is described from macroscopic viewpoint.

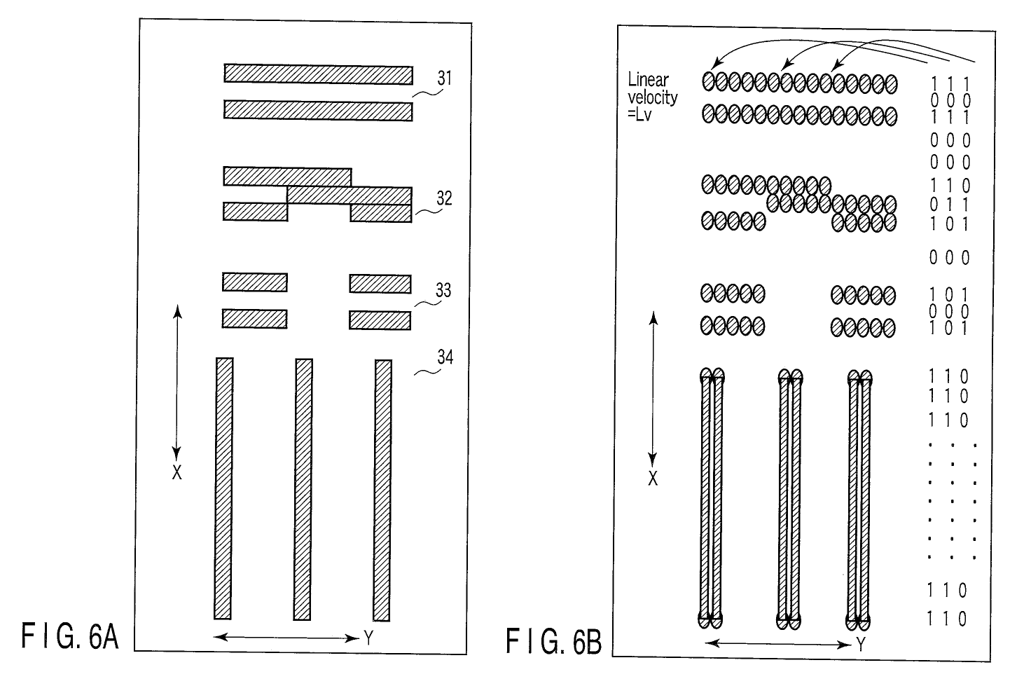

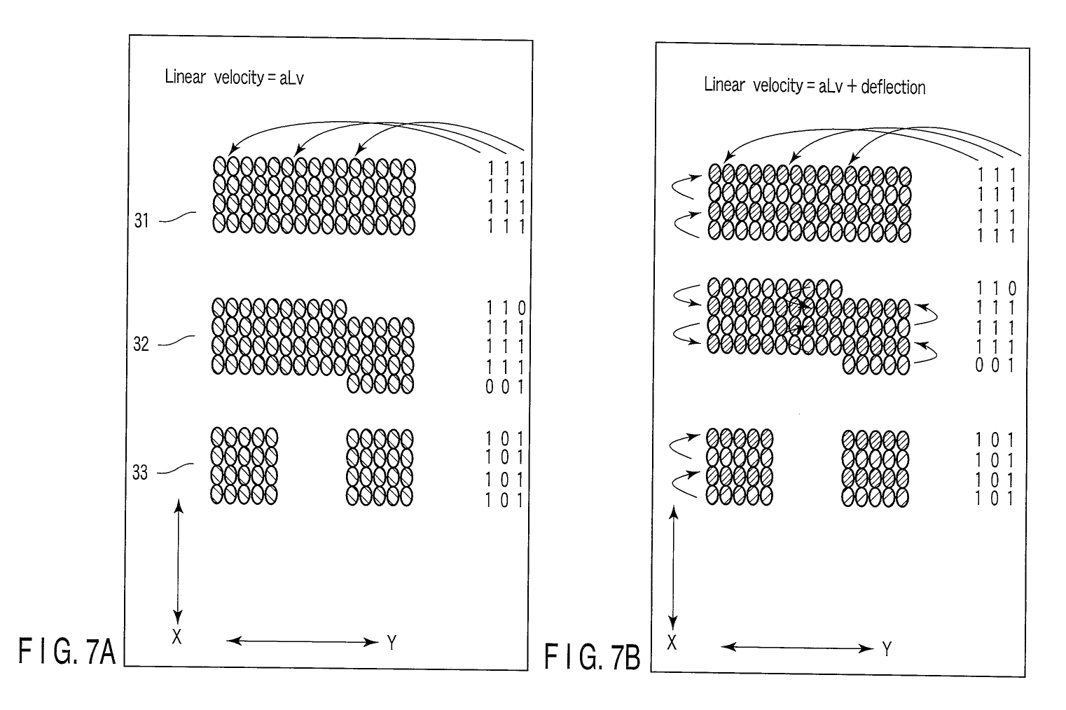

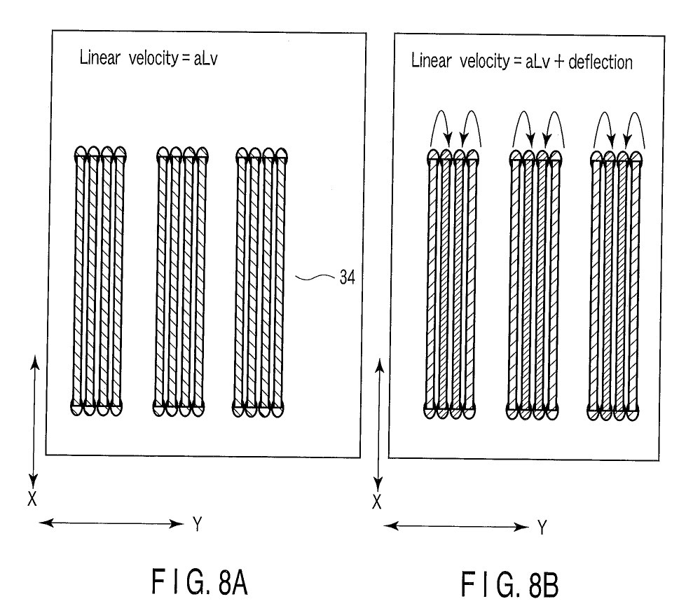

FIG. 6A illustrates an example of a desired pattern, and FIG. 6B illustrates an example of a conventional drawing method. FIG. 7A illustrates an example of the concept of the method for drawing the pattern corresponding to FIG. 6A which extends to the radial direction (Y direction) according to the present invention, and FIG. 7B illustrates an example of the drawing method of the present invention. FIG. 8A illustrates an example of concept of the method for drawing the pattern corresponding to FIG. 6A which extends to the circumferential direction (X direction) according to the present invention, and FIG. 8B illustrates an example of the drawing method of the present invention.

FIG. 6A illustrates the desired patterns of a preamble section 31, an address section 32, a burst section 33 and tracks 34. In the conventional method, as shown in FIG. 6B, predetermined signals are given from a signal generator (hereinafter, also referred to as a signal source) to a deflecting system of the electron beam drawing apparatus at a certain linear velocity Lv. In FIG. 6A, a case where a beam is applied is represented by 1, and a case where a beam is blanked so as not to be applied is represented by 0. A pattern is formed by plural circulations of drawing for one track. The pattern in the radial direction is formed by arranging an exposed portion and a non-exposed portion in the radial direction every circulation. The track pattern in the circumferential direction is formed at a desired pitch by regularly arranging a circulation for exposure and a circulation for unexposure in the radial direction on a predetermined angular position.

On the contrary, the concept of the drawing method according to the present invention is shown in FIG. 7A. In the present invention, the linear velocity is a*Lv which is a-times the conventional velocity. The electron beam irradiation time is also a-times the conventional one. That is, a beam is applied also at time when the beam is blanked conventionally. Although “a” may be set that a>1, when Manchester codes are used or a stripe pattern of 1:1 which extends to the radial direction is provided, “a” is set that a≧2, in general.

In the pattern with a gap in the circumferential direction, when the electron beam irradiation position is moved to the circumferential direction, the electron beam irradiation time can be extended. In a case of a track pattern without a gap in the circumferential direction, however, when the electron beam irradiation position is moved to the circumferential direction, the electron beam irradiation time cannot be extended. In a circulation on the adjacent portion which conventionally does not generate a signal 1, the number of circulations with which the signal 1 is generated is increased so that the electron beam irradiation time extends to be b-times the conventional one at the circulation at which the signal 1 is generated. The “b” is preferably a numerical value close to the “a” in view of the adjustment of the exposure amount. If only such a numerical value is satisfied, a desired pattern cannot be obtained, blurred or thickened in the radial direction, and thus the beam irradiation position is collected to a position where the electron beam should be deflected and originally drawn, namely, a position which is irradiated in the conventional method. As to the pattern which extends to the radial direction, the electron beam is deflected as shown by arrows in FIG. 7B. The deflection direction of the electron beam can be changed depending on patterns. As to the pattern which extends to the circumferential direction, the electron beam is deflected as shown by arrows in FIG. 8B.

Also in conventional methods, the time 1 and the time 0 do not have to be equal to each other. When a positive resist is used, a pattern after development generally becomes larger than an exposure pattern. When a discrete-type magnetic disk medium is manufactured using imprinting, a pattern occasionally becomes thicker than a master during processes. For this reason, even when the pattern of 1:1 is desired on a medium, the exposure pattern does not always have to be formed at 1:1. For example, when a positive resist is exposed so that a master is manufactured, an exposed portion is formed in a recess and an unexposed portion is formed in a protrusion. When a stamper whose recess and protrusion are reversed is manufactured by using this resist pattern and the pattern is transferred using this stamper, a portion corresponding to the unexposed portion becomes a protrusion on the medium. When the recess becomes wide in processing the recess using the protrusion as a mask, unexposed portions corresponding to the widened recess of the medium should be provided at ratio larger than a desired ratio, and thus the ratio of the exposed portions is desirably a half or less.

Since the stage continues to rotate during drawing, when an electron beam is deflected to the circumferential direction and a pattern which extends to the radial direction is drawn, the electron beam is deflected to a direction parallel with a rotational direction of the substrate such that a relative movement speed of an electron-beam applied position on the substrate in the direction parallel with the rotational direction of the substrate becomes slower than a linear velocity of the substrate, viewed from a drawing start position in a circulation for drawing the pattern. In the case where the movement speed of the electron beam is V and the linear velocity of the substrate is L, if the relationship of L/2≦V<L is established, the blanking time is decreased, and the pattern can be drawn efficiently. For this reason, this method is preferable.

When two bits to be exposed continue, the following is performed. Before the substrate comes to a bit position of the two bits to be first exposed and when a bit start position one previous to the bit position to be first exposed is on a non-deflection drawing position, the bit to be first exposed is started to be drawn. An electron beam is deflected to the opposite direction to the rotational direction of the stage within a range which is not more than twice a bit length on the radial position where this bit is present at this time. The electron beam is deflected to the opposite direction to the rotational direction of the stage during the exposure of the first bit, and the electron beam is deflected to the same direction as the rotational direction of the stage during the exposure of the second bit. As a result, even when two bits to be exposed continue, the method of the present invention can be used effectively.

Also when the pattern which extends to the circumferential direction is drawn, the exposure time should be shortened. Thus, the electron beam is deflected to the radial direction in the circulation on a position vicinity to the pattern, and the pattern portion may be multiply exposed.

The discrete-type magnetic disk patterns such as the preamble pattern and the discrete track pattern can be formed in such a manner.

The stamper which is manufactured by using the electron beam drawing method of the present invention is described. The stamper may have a disk shape, a doughnut shape or another shape. A thickness of the stamper is desirably 0.1 mm or more and 2 mm or less. When the stamper is too thin, satisfactory strength cannot be obtained. When the stamper is too thick, electroforming requires long time, and thickness difference becomes large. A size of the stamper is preferably larger than the medium, but the size is not particularly limited. The resultant stamper is used for manufacturing the discrete-type magnetic disk by imprinting. The discrete-type magnetic disk may be magnetic film-patterned discrete track media or substrate-patterned discrete track media.

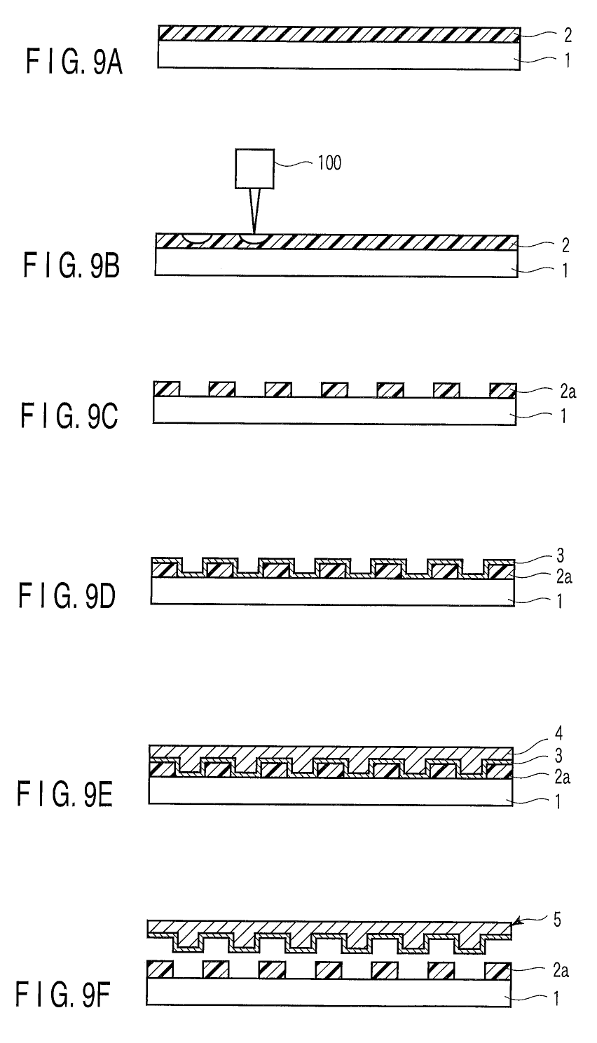

A method of manufacturing a stamper is described with reference to FIGS. 9A to 9F. In order to manufacture a stamper, the electron beam drawing apparatus, which has the stage on which a stamper substrate is placed, a movement mechanism which moves the stage to the horizontal direction and the rotating mechanism which rotates the stage, is used.

As shown in FIG. 9A, resist (photosensitive resin) 2 is applied to the stamper substrate 1. The stamper substrate 1 is placed on the stage of the electron beam drawing apparatus, and as shown in FIG. 9B, an electron beam is applied from an electron gun 100 so that a predetermined pattern is drawn. In this step, the stamper substrate 1 on the stage is rotated and is simultaneously moved to the horizontal direction, while the electron beam is deflected to a predetermined direction, thereby drawing the pattern. The pattern may be drawn from an inner periphery to an outer periphery or from the outer periphery to the inner periphery. As shown in FIG. 9C, the pattern is developed so that a resist pattern 2a is formed. As shown in FIG. 9D, a conductive film 3 is formed on a surface of the resist pattern 2a by sputtering. As shown in FIG. 9E, recessed of the resist pattern 2a is filled by electroforming, and a Ni film 4 with a desired thickness is formed. As shown in FIG. 9F, the Ni film 4 with the conductive film 3 is peeled so that a stamper 5 is formed. Further, oxygen RIE (reactive ion etching) is carried out so that the resist is removed from the stamper 5.

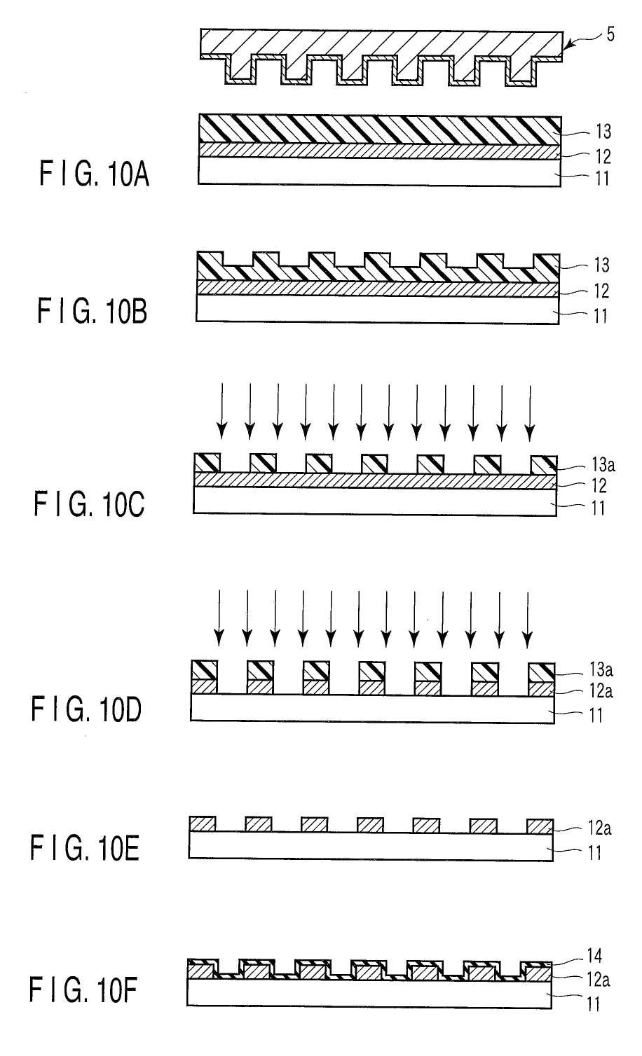

A method of manufacturing a magnetic film-patterned discrete-type magnetic disk using the stamper is describe with reference to FIGS. 10A to 10F. As shown in FIG. 10A, a magnetic layer 12 to be a recording layer is deposited on the substrate 11 for the magnetic disk, and a resist 13 is applied to the magnetic layer 12. The stamper 5 is arranged so as to be opposed to the resist 13. As shown in FIG. 10B, the stamper 5 is imprinted so that the pattern is transferred to the resist 13. As shown in FIG. 10C, resist residues which remain on bottoms of the recesses of the resist 13 are removed, so that resist patterns 13a are formed. As shown in FIG. 10D, the magnetic layer 12 is subjected to ion milling by using the resist patterns 13a as masks. As shown in FIG. 10E, the resist patterns 13a are removed, and discrete magnetic patterns 12a are formed. As shown in FIG. 10F, a protective film 14 is formed on the entire surface, so that the discrete-type magnetic disk is manufactured.

The shape of the substrate 11 is not particularly limited, but a disk shape is preferable, and a silicon wafer or the like is used. As the substrate, a glass substrate, an Al alloy substrate, a ceramic substrate, a carbon substrate, a compound semiconductor substrate or the like can be used. As the glass substrate, amorphous glass or crystallized glass can be used. Examples of the amorphous glass are soda-lime glass and aluminosilicate glass. An example of the crystallized glass is lithium-series crystallized glass. Examples of the ceramic substrate are sintered bodies mainly containing aluminum oxide, aluminum nitride or silicon nitride, and materials obtained by fiber-reinforcing the sintered bodies. Examples of the compound semiconductor substrate are GaAs, AlGaAs.

The magnetic disk preferably has a donut shape. A size of the magnetic disk is not particularly limited, but 3.5 inches or less is desirable so that the drawing time using an electron beam is not excessive. Further, 2.5 inches or less is desirable so that pressure in imprinting is not excessive. In view of the mass productivity, sizes of 1.8 inch, 1 inch or 0.85 inch are desirable so that the electron beam drawing time can be relatively short and the pressure in the imprinting can be low. A surface to be used as the magnetic disk may be single sided or double sided.

The surface of the magnetic disk is defined by concentric tracks, and sectors obtained by dividing each track at every constant angle are formed. Whereas the tracks are arranged in the circumferential direction, servo zones for position control are arranged in the direction crossing tracks. The servo zone includes sections such as a preamble section, an address section in which information about tracks or sector numbers are written, and a burst section for detecting relative position of a head with respect to a track. The servo zone may include a gap in addition to these sections. The magnetic disk is mounted to a spindle motor and is rotated, and various digital data are written and read out with the head.

The track pitch is required to be narrow in view of the improvement in recording density. On one track, a track magnetic pattern and a nonmagnetic material to be a separating portion are formed, and an address bit and a burst mark of corresponding servo zone should be formed. For this reason, a pattern is required to be drawn so that one track is formed by a several times or a several tens times of circulations in cutting. When the number of cutting circulations is small, shape resolution becomes low, and thus the pattern shape cannot be satisfactorily reflected. When the number of the cutting circulations is large, control signals are made complicated and their capacity increase. For this reason, it is desirable that one track is formed by circulations in a range of 6 or more and 36 or less. It is advantageous that the numerical value of the number of circulations has a lot of divisors in view of design for pattern arrangement.

Since the sensitivity of the resist to be exposed is normally uniform in the plane, it is desirable that the stage of the electron beam drawing apparatus rotates with constant linear velocity. For example, when the track pitch is 300 nm and one track is tried to be formed by 12 cutting circulations, the cutting track pitch becomes 25 nm (=300÷12). The cutting track pitch is desirably not more than a beam diameter in order to eliminate an insufficiently exposed area and an undeveloped area.

Examples of the present invention are described below.

### EXAMPLE 1

An example that a discrete track medium is manufactured by using the methods shown in FIGS. 9A to 9F and 10A to 10F is described.

An electron beam drawing apparatus whose acceleration voltage is 50 kV was used. The apparatus has a ZrO/W thermal field emission electron gun emitter including an electron gun, a condenser lens, an objective lens, a blanking electrode and a deflector.

On the other hand, resist ZEP-520 manufactured by ZEON corporation was diluted with anisole to two times, and was filtered by a membrane filter with 0.2 μm. After the stamper substrate 1 made of 8-inch silicon wafer subjected to HMDS treatment was spin-coated with a resist solution, the stamper substrate 1 was prebaked at 200° C. for 3 minutes, so that the resist 2 with thickness of 0.1 μm was formed (FIG. 9A).

The stamper substrate 1 was carried to a predetermined position in the electron beam drawing apparatus, and was exposed under vacuum and the following conditions so that concentric patterns were drawn (FIG. 9B).

Radius of the exposed portion: 4.8 mm to 10.2 mm

The number of sectors/track: 150

The number of bits/sector: 4000

Track pith: 300 nm

A moving amount per one rotation: 20 nm

The number of exposure circulations per track: 15 circulations

The number of exposure circulations per burst mark: 10 circulations

Linear velocity: 1.0 m/s (constant)

At this time, deflection strength was gradually increased during one rotation, and a concentric circle was drawn. The servo zone includes a preamble pattern, a burst pattern, an address pattern, and a gap. The tracks occupy 90% of the area of sectors.

When the preamble pattern, the burst pattern and the address pattern on the servo zone were exposed, an electron beam was deflected to the circumferential direction, and the movement speed of the beam was 0.6 m/s. On an angle position where a groove of the track was present, one track was exposed in 8 circulations and was not exposed in 7-circulations. The electron beam was deflected to the radial direction in each two circulations of the 8 circulations from the outer side, so that these electron beams were uniformly overlapped with electron beams on the inner four circulations.

The stamper substrate 1 was immersed into a developer (for example, ZED-N50 manufactured by ZEON corporation) for 90 seconds and the resist was developed. Thereafter, the stamper substrate 1 was immersed into a rinse liquid (for example ZMD-B manufactured by ZEON corporation) for 90 seconds so as to be rinsed. The stamper substrate 1 was dried by air blow, so that the resist master was manufactured (FIG. 9C).

The conductive film 3 was formed on the resist master by sputtering. Pure nickel was used as a target, and the sputtering camber was evacuated to 8×10⁻³ Pa. Thereafter, argon gas was introduced into the sputtering camber and adjusted to 1 Pa, and a DC power of 400 W was applied, and sputtering was performed for 40 seconds, so that the conductive film 3 of 30 nm was obtained (FIG. 9D).

The resist master with the conductive film 3 was electroformed for 90 minutes by using nickel sulfamate liquid (NS-160 manufactured by SHOWA CHEMICAL CO., LTD) (FIG. 9E). The electroforming bath conditions are as follows:

Nickel sulfamate: 600 g/L

Boric acid: 40 g/L

Surfactant (sodium lauryl sulfate): 0.15 g/L

Liquid temperature: 55° C.

pH: 4.0

Current density: 20 A/dm²

A thickness of an electroformed Ni film 4 was 300 μm. The Ni film 4 with the conductive film 3 was peeled from the resist master so that the stamper 5 was obtained (FIG. 9F). Thereafter, resist residues were removed by oxygen plasma ashing. An oxygen gas was introduced in a chamber at 100 ml/min and adjusted to vacuum of 4 Pa, and plasma ashing was carried out at 100 W for 20 minutes. An unnecessary portion of the obtained stamper 5 was punched with a metal blade, so that the stamper 5 for imprinting was obtained.

After the stamper 5 was sonic-cleaned for 15 minutes by acetone, the stamper 5 was soaked in a solution which was obtained by diluting fluoroalkylsilane [CF₃(CF₂)₇CH₂CH₂Si(OMe)₃] (TSL 8233 manufactured by GE Toshiba Silicones Co., Ltd) to 5% using ethanol for 30 minutes. After the solution was blown away with a blower, the stamper 5 was annealed at 120° C. for 1 hour.

The magnetic recording layer 12 was deposited on the donut-shaped glass substrate 11 of 0.85 inch by sputtering, and was spin-coated with novolac resist (S1801 manufactured by Rohm and Haas Company) 13 at 3800 rpm (FIG. 10A). The stamper 5 was pressed at 2000 bar for 1 minute, so that the pattern was transferred to the resist 13 (FIG. 10B). After the resist 13 to which the pattern was transferred was irradiated with UV for 5 minutes, it was baked at 160° C. for 30 minutes.

The imprinted substrate 11 was subject to oxygen RIE under the pressure of 2 mTorr by using an ICP (induction coupled plasma) etching apparatus. Resist residues remaining on the bottoms of the recesses of the resist 13 were removed so that the resist patterns 13a were formed (FIG. 10C). The magnetic recording layer 12 was etched by Ar ion milling using the resist patterns 13a as masks, so that the magnetic patterns 12a were formed (FIG. 10D). Oxygen RIE was carried out under 1 Torr at 400 W, so that the resist patterns 13a were stripped (FIG. 10E). DLC (diamond like carbon) with a thickness of 3 nm was deposited by CVD (chemical vapor deposition method), so that the protective film 14 was formed (FIG. 10F). Further, lubricant was applied to the protective film 14 by dipping to a thickness of 1 nm.

The discrete track medium which was manufactured in such a manner was incorporated into a magnetic recording apparatus, and signals were detected. As a result, satisfactory burst signals were obtained, and head positioning could be controlled suitably. The grooves between the tracks had a width of 85 nm.

### EXAMPLE 2

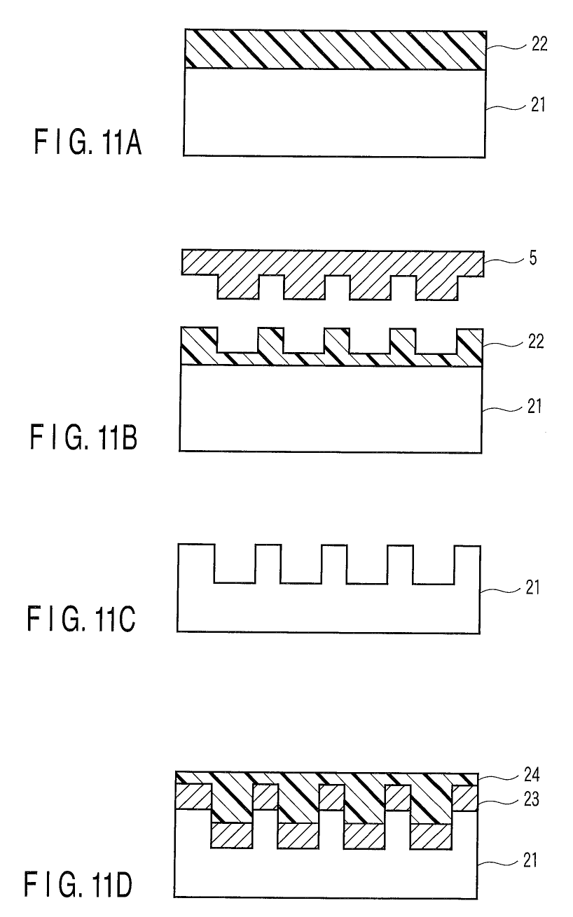

An example that a substrate-patterned discrete track medium is manufactured by using the method shown in FIGS. 11A to 11D is described.

A stamper was manufactured by the method shown in FIGS. 9A to 9F. Also in this case, the electron beam drawing method of the present invention was used in the step of FIG. 9B.

A substrate having patterns of protrusions and recesses is manufactured by using imprint lithography.

As shown in FIG. 11A, a resist 22 is applied to a substrate 21. As shown in FIG. 11B, the stamper 5 is opposed to the resist 22, and the pattern of the stamper 5 is transferred to the resist 22 with pressure being applied. Thereafter, the stamper 5 is removed, and the resist patterns 22a are formed. As shown in FIG. 11B, after the substrate 21 is etched using the resist patterns 22a as masks, the resist patterns are removed. As shown in FIG. 11D, a soft magnetic underlayer (not shown) and a magnetic recoding layer 23 are deposited on the substrate 21, and the magnetic recording layer 23 is formed on the protrusions and recesses of the substrate 21. A carbon protective film 24 is deposited thereon. Lubricant is applied so that a substrate-patterned discrete track medium is manufactured.

The obtained discrete track medium was incorporated into a magnetic recording device and signals were detected. Satisfactory burst signals were obtained, and head positioning could be controlled suitably. The grooves between the tracks had a width of 85 nm.

### EXAMPLE 3

An example where a discrete track medium is manufactured by using the methods shown in FIGS. 9A to 9F and 10A to 10F is described.

The electron beam drawing apparatus similar to example 1 was used. The resist 2 was applied to the substrate 1 similarly to example 1 (FIG. 9A). When the preamble pattern, burst pattern and address pattern in the servo zone were exposed, an electron beam was deflected to the circumferential and radial directions. The movement speed of the beam to the circumferential direction was set to 0.6 m/s. In the radial direction, the electron beam was deflected by ±7 nm from a standard radius position to right and left sides in the radial direction every time of exposure of the portion corresponding to one bit. Except for these conditions, conditions similar to those in example 1 were used so that the drawing was carried out. The number of deflections to right and left may be a plurality of times. Similarly to example 1, a discrete track medium was manufactured.

The discrete track medium which was manufactured in such a manner was incorporated into the magnetic recording apparatus, and signals were detected. As a result, satisfactory burst signals were obtained, and head positioning could be controlled suitably.

### COMPARATIVE EXAMPLE

The substrate was rotated at a speed which is half of that in the example 1 in drawing, and an electron beam was not deflected except for the deflection in drawing concentric circles. A beam irradiation time was reduced to half on the servo zone having a pattern in the radial direction, and an electron beam drawing on the grooves between the tracks was carried out in four circulations per track. Except for these conditions, conditions similar to those in example 1 were used, so that a discrete track medium was manufactured.

With this method, the discrete track medium similar to that in example 1 could be obtained, but it took a double time to manufacture the stamper.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An electron beam drawing method comprising:
providing an electron beam drawing apparatus having a stage on which a substrate is placed, a movement mechanism which moves the stage to a horizontal direction and a rotation mechanism which rotates the stage; and
placing the substrate, on which a photosensitive resin film is coated, on the stage, applying an electron beam to the photosensitive resin film while the substrate on the stage is rotated and moved to the horizontal direction, and drawing a pattern extending to a radial direction,
wherein the electron beam is deflected to a direction parallel with a rotational direction of the substrate such that a relative movement speed of an electron-beam applied position on the substrate in the direction parallel with the rotational direction of the substrate becomes slower than a linear velocity of the substrate, viewed from a drawing start position in a circulation for drawing the pattern.

2. The method of claim 1, wherein the electron beam is deflected to the direction parallel with the rotational direction of the substrate and also to the radial direction.

3. The method of claim 1, wherein assuming that a movement speed of the electron beam is V and a linear velocity of the substrate is L, the following relationship is satisfied: L/2≦V<L, and wherein the electron beam is deflected such that the electron beam applied position on the substrate moves to the same direction as the rotational direction of the substrate.

4. The method of claim 1, wherein the electron beam is deflected to an opposite direction to the rotational direction of the substrate within a range which is not more that twice a bit length on a radial position where the bit is present at the time when that bit is started to be drawn.

5. The method of claim 1, wherein the photosensitive resin film is a positive photosensitive resin film.

6. The method of claim 1, wherein, in drawing a pattern extending to a circumferential direction, an electron beam is deflected to the radial direction in a circulation on a vicinity of the pattern, so that the pattern is multiply exposed.

7. The method of claim 1, wherein a preamble pattern is formed.

8. The method of claim 6, wherein a discrete track pattern is formed.

9. The method of claim 1, wherein patterns of a discrete-type magnetic disk are formed.
